(19) United States
(12) Patent Application Publication
(10) Pub. No.: US 2013/0024122 A1
(43) Pub. Date: Jan. 24, 2013

(54) FORMATION FLUID DETECTION

(71) Applicants: Peihu Wang, Beijing (CN); Ju Chen, Beijing (CN); Yao Liu, Beijing (CN)

(72) Inventors: Peihu Wang, Beijing (CN); Ju Chen, Beijing (CN); Yao Liu, Beijing (CN)

(73) Assignee: SCHLUMBERGER TECHNOLOGY CORPORATION, Houston, TX (US)

(21) Appl. No.: 13/185,178

(22) Filed: Jul. 18, 2011

(51) Int. Cl. G06F 19/00; E21B 47/00

(52) U.S. Cl. 702/11; 73/152.55

(57) ABSTRACT

A method for downhole fluid analysis comprising: receiving fluid property data for two fluids from a device in a borehole; the fluid property data including temperature data of the fluids and resistivity data of the fluids; in real time with receiving the fluid property data, deriving correlation between the temperature data and the resistivity data for each fluid; and evaluating the correlation of the fluids.

### BACKGROUND OF INVENTION

1. Field of the Invention

The present invention relates to the analysis of formation fluids for evaluating and testing a geological formation for purposes of exploration and development of hydrocarbon-producing wells, such as oil or gas wells. More particularly, the present invention is directed to system and methods of detecting formation fluid.

2. Background Art

Downhole fluid analysis (DFA) is an important and efficient investigative technique typically used to ascertain the characteristics and nature of geological formations having hydrocarbon deposits. DFA is used in oilfield exploration and development for determining petrophysical, mine ralogical, and fluid properties of hydrocarbon reservoirs. DFA is a class of reservoir fluid an analysis including composition, fluid properties and phase behavior of the downhole fluids for characterizing hydrocarbon fluids and reservoirs.

Typically, a complex mixture of fluids, such as oil, gas, and water, is found downhole in reservoir formations. The downhole fluids, which are also referred to as formation fluids, have characteristics, including pressure, live fluid color, dead-crude density, gas-oil ratio (GOR), among other fluid properties, that serve as indicators for characterizing hydrocarbon reservoirs. In this, hydrocarbon reservoirs are analyzed and characterized based, in part, on fluid properties of the formation fluids in the reservoirs.

In order to evaluate the nature of underground formations surrounding a borehole, it is often desirable to obtain and analyze samples of formation fluids from a plurality of specific locations in the borehole. Over the years, various fluid analysis modules have been developed for use in connection with sampling tools, such as the MDT tool, in order to identify and characterize the samples of formation fluids drawn by the sampling tool. For example, Schlumberger's U.S. Pat. No. 4,994,671 (also incorporated herein by reference) describes an exemplary fluid analysis module that includes a testing chamber, a light source, a spectral detector, a database, and a processor. Fluids drawn from the formation into the testing chamber by a fluid admitting assembly are analyzed by directing light at the fluids, detecting the spectrum of the transmitted and/or backscattered light, and processing the information (based on information in the database relating to different spectra) in order to characterize the formation fluids. Schlumberger's U.S. Pat. Nos. 5,167,149 and 5,201,220 (both of which are incorporated by reference herein) also describe reflecting light from a window/fluid flow interface at certain specific angles to determine the presence of gas in the fluid flow. In addition, as described in U.S. Pat. No. 5,331,156, by taking optical density (OD) measurements of the fluid stream at certain predetermined energies, oil and water fractions of a two-phase fluid stream may be quantified. As the techniques for measuring and characterizing formation fluids have become more advanced, the demand for more precise and expandable formation fluid analysis tools has increased.

In addition, various tools and procedures have been developed to facilitate this formation fluid evaluation process. Examples of such tools can be found in U.S. Pat. No. 6,476,384 (“the '384 patent”), assigned to Schlumberger Technology Corporation. The disclosure of this '384 patent is hereby incorporated by reference as though set forth at length. Schlumberger's Repeat Formation Tester (RFT) and Modular Formation Dynamics Tester (MDT) tools are specific examples of sampling tools as described in the '384 patent. In particular, Schlumberger's MDT tool may include one or more fluid analysis modules, such as the Composition Fluid Analyzer (CFA) and Live Fluid Analyzer (LFA) of Schlumberger, to analyze downhole fluids sampled by the tool while the fluids are still downhole.

### SUMMARY OF INVENTION

One aspect of the invention relates to methods for downhole fluid analysis. A method in accordance with one embodiment of the invention includes the steps of: receiving fluid property data for two fluids from a device in a borehole; the fluid property data including temperature data of the fluids and resistivity data of the fluids; in real time with receiving the fluid property data, deriving correlation between the temperature data and the resistivity data for each fluid; and evaluating the correlation of the fluids.

Another aspect of the invention relates to methods of comparing two fluids. A method in accordance with one embodiment of the invention includes the steps of: acquiring fluid property data for the two fluids from a device in a borehole, the fluid property data including temperature data of the two fluids and resistivity data of the two fluids; and analyzing the two fluids based upon correlations of the two fluids, the correlation of each fluid identifying relationship between the temperature data and the resistivity data of each fluid.

Still another aspect of the invention relates to formation fluid detectors configured to operate downhole. A formation fluid detector in accordance with one embodiment of the invention includes: a temperature sensor in contact with fluid acquiring temperature data of the fluid; a resistivity unit in contact with the fluid providing resistivity data of the fluid; and a processor coupled to the temperature sensor and the resistivity unit, in real time with receiving the temperature data and the resistivity data of the fluid, deriving correlation between the temperature data and the resistivity data; and evaluating the correlation of the fluid.

Other aspects and advantages of the invention will be apparent from the following description and the appended claims.

### BRIEF DESCRIPTION OF DRAWINGS

The accompanying drawings illustrate preferred embodiments of the present invention and are a part of the specification. Together with the following description, the drawings demonstrate and explain principles of the present invention.

FIG. 1 is a schematic representation in cross-section of an exemplary operating environment of the present invention.

FIG. 2 is a schematic representation of one system according to the present invention.

FIG. 3 is a schematic representation of one fluid analysis module apparatus for according to the present invention.

FIG. 4 shows graphical representation of the time elapse and resistivity data plot in accordance with a conventional method.

FIG. 5 represents in a flowchart a method for formation fluid detection according to the present invention.

FIG. 6 shows graphical representation of the temperature data and resistivity data log—log plot in accordance with one embodiment of the invention.

FIG. 7 shows graphical representation of the temperature data and resistivity data log—log plot in accordance with another embodiment of the invention.

### DETAILED DESCRIPTION

Illustrative embodiments and aspects of the invention are described below. In the interest of clarity, not all features of an actual implementation are described in the specification. It will of course be appreciated that in the development of any such actual embodiment, numerous implementation-specific decisions must be made to achieve the developers' specific goals, such as compliance with system-related and business-related constraints, that will vary from one implementation to another. Moreover, it will be appreciated that such development effort might be complex and time-consuming, but would nevertheless be a routine undertaking for those of ordinary skill in the art having benefit of the disclosure herein.

The present invention is applicable to oilfield exploration and development in areas such as wireline and logging-while-drilling (LWD) downhole fluid analysis using fluid analysis modules, such as Schlumberger's Composition Fluid Analyzer (CFA) and/or Live Fluid Analyzer (LFA) modules, in a formation tester tool, for example, the Modular Formation Dynamics Tester (MDT). As used herein, the term “real-time” refers to data processing and analysis that are substantially simultaneous with acquiring a part or all of the data, such as while a borehole apparatus is in a well or at a well site engaged in logging or drilling operations.

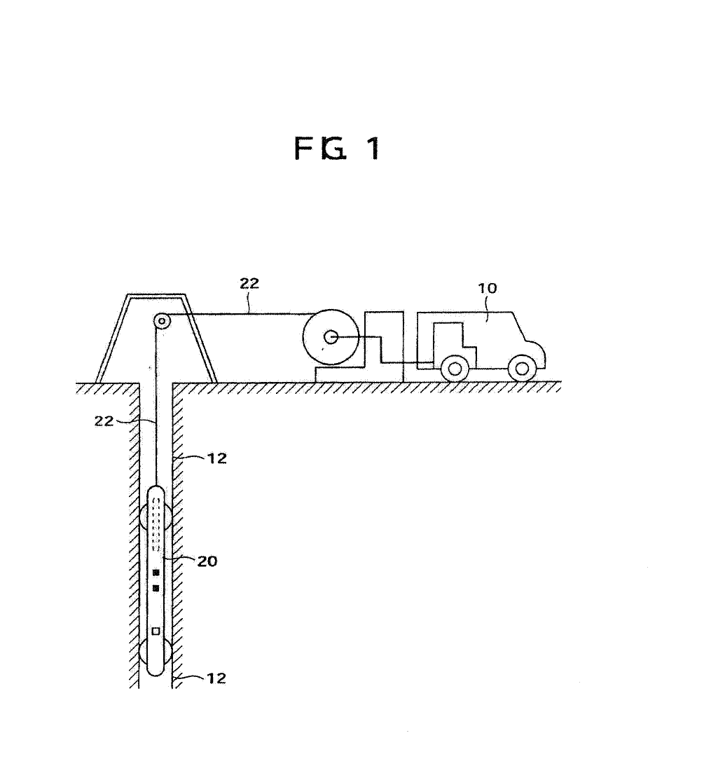

FIG. 1 is a schematic representation in cross-section of an exemplary operating environment of the present invention. Although FIG. 1 depicts a land-based operating environment, the present invention is not limited to land and has applicability to water-based applications, including deepwater development of oil reservoirs. Furthermore, although the description herein uses an oil and gas exploration and production setting, it is believed that the present invention has applicability in other settings, such as water reservoirs.

In FIG. 1, a service vehicle 10 is situated at a well site having a borehole 12 with a borehole tool 20 suspended therein at the end of a wireline 22. Typically, the borehole 12 contains a combination of fluids such as water, mud, formation fluids, etc. The borehole tool 20 and wireline 22 typically are structured and arranged with respect to the service vehicle 10 as shown schematically in FIG. 1, in an exemplary arrangement.

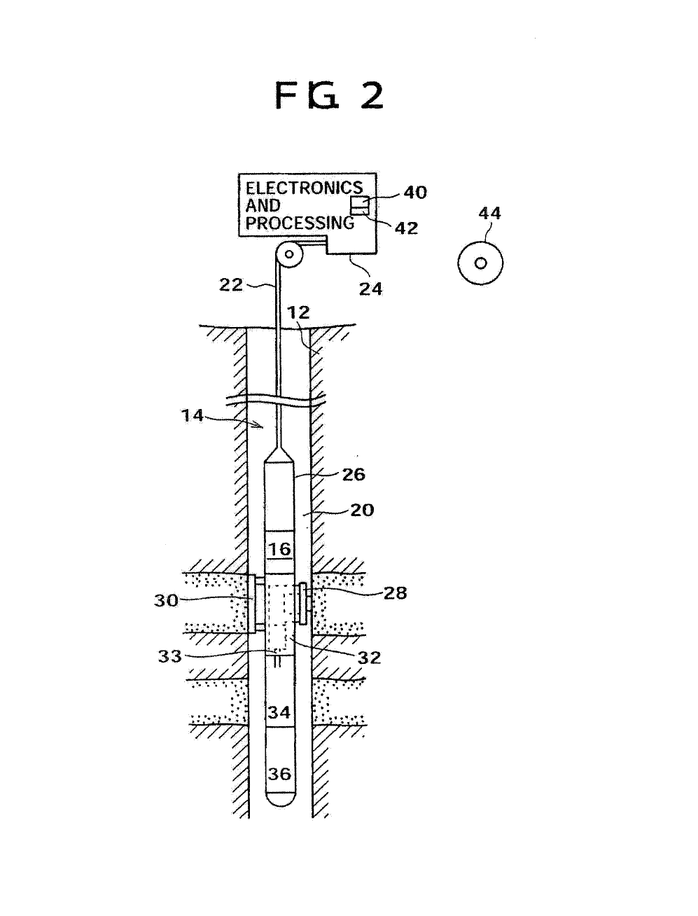

FIG. 2 discloses one exemplary system 14 in accordance with the present invention for detecting formation fluid, for example, while the service vehicle 10 is situated at a well site (note FIG. 1). The borehole system 14 includes a borehole tool 20 for testing earth formations and analyzing the composition of fluids that are extracted from a formation and/or borehole. In a land setting of the type depicted in FIG. 1, the borehole tool 20 typically is suspended in the borehole 12 (note FIG. 1) from the lower end of a multi-conductor logging cable or wireline 22 spooled on a winch (note again FIG. 1) at the formation surface. In a typical system, the logging cable 22 is electrically coupled to a surface electrical control system 24 having appropriate electronics and processing systems for control of the borehole tool 20.

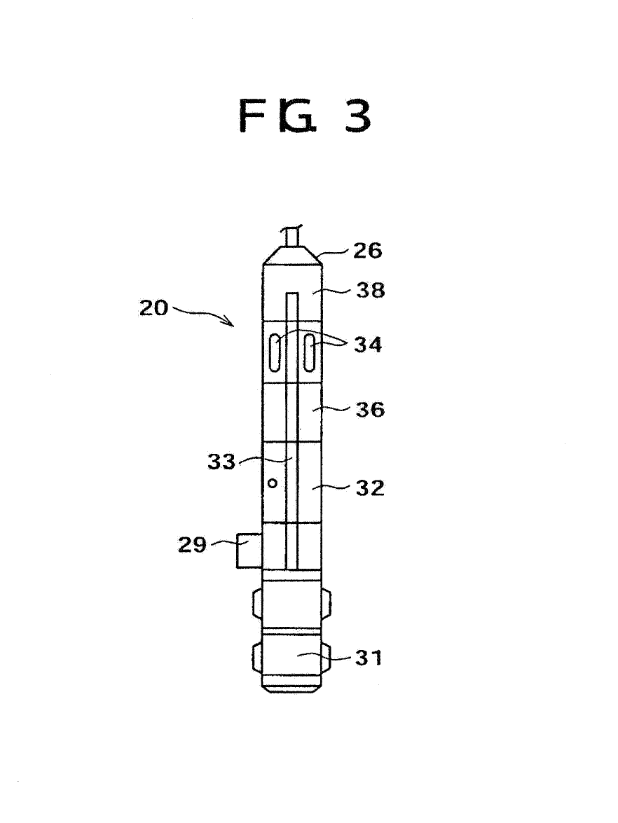

Referring also to FIG. 3, the borehole tool 20 includes an elongated body 26 encasing a variety of electronic components and modules, which are schematically represented in FIGS. 2 and 3, for providing necessary and desirable functionality to the borehole tool string 20. A selectively extendible fluid admitting assembly 28 and a selectively extendible tool-anchoring member 30 (note FIG. 2) are respectively arranged on opposite sides of the elongated body 26. Fluid admitting assembly 28 is operable for selectively sealing off or isolating selected portions of a borehole wall 12 such that pressure or fluid communication with adjacent earth formation is established. In this, the fluid admitting assembly 28 may be a single probe module 29 (depicted in FIG. 3) and/or a packer module 31 (also schematically represented in FIG. 3).

One or more fluid analysis modules 32 are provided in the tool body 26. Fluids obtained from a formation and/or borehole flow through a flowline 33, via the fluid analysis module or modules 32, and then may be discharged through a port of a pumpout module 38 (note FIG. 3). Alternatively, formation fluids in the flowline 33 may be directed to one or more fluid collecting chambers 34 and 36, such as 1, 23/4, or 6 gallon sample chambers and/or six 450 cc multi-sample modules, for receiving and retaining the fluids obtained from the formation for transportation to the surface.

The fluid admitting assemblies, one or more fluid analysis modules, the flow path and the collecting chambers, and other operational elements of the borehole tool string 20, are controlled by electrical control systems, such as the surface electrical control system 24 (note FIG. 2). Preferably, the electrical control system 24, and other control systems situated in the tool body 26, for example, include processor capability for deriving fluid properties, comparing fluids, and executing other desirable or necessary functions with respect to formation fluids in the tool 20, as described in more detail below.

The system 14 of the present invention, in its various embodiments, preferably includes a control processor 40 operatively connected with the borehole tool string 20. The control processor 40 is depicted in FIG. 2 as an element of the electrical control system 24. Preferably, the methods of the present invention are embodied in a computer program that runs in the processor 40 located, for example, in the control system 24. In operation, the program is coupled to receive data, for example, from the fluid analysis module 32, via the wireline cable 22, and to transmit control signals to operative elements of the borehole tool string 20.

The computer program may be stored on a computer usable storage medium 42 associated with the processor 40, or may be stored on an external computer usable storage medium 44 and electronically coupled to processor 40 for use as needed. The storage medium 44 may be any one or more of presently known storage media, such as a magnetic disk fitting into a disk drive, or an optically readable CD-ROM, or a readable device of any other kind, including a remote storage device coupled over a switched telecommunication link, or future storage media suitable for the purposes and objectives described herein.

In embodiments of the present invention, the methods and apparatus disclosed herein may be embodied in one or more fluid analysis modules of Schlumberger's formation tester tool, the Modular Formation Dynamics Tester (MDT). The present invention advantageously provides a formation tester tool, such as the MDT, with enhanced functionality for downhole analysis and collection of formation fluid samples. In this, the formation tester tool may be advantageously used for sampling formation fluids in conjunction with downhole fluid analysis.

Formation testing has been used extensively for pressure measurements and sampling. Downhole fluids analysis technology allows the real time quality control of sampling. In order to obtain clean formation fluids, field engineers often use the pump module of the MDT to pump out mud filtrate before taking the sample. For the oil based mud, by monitoring Downhole Fluids Analysis (DFA) plot and an oil-base mud contamination monitoring (OCM) plot, field engineers can determine whether clean formation fluids flow into flowline. This method can quantify contamination in real time.

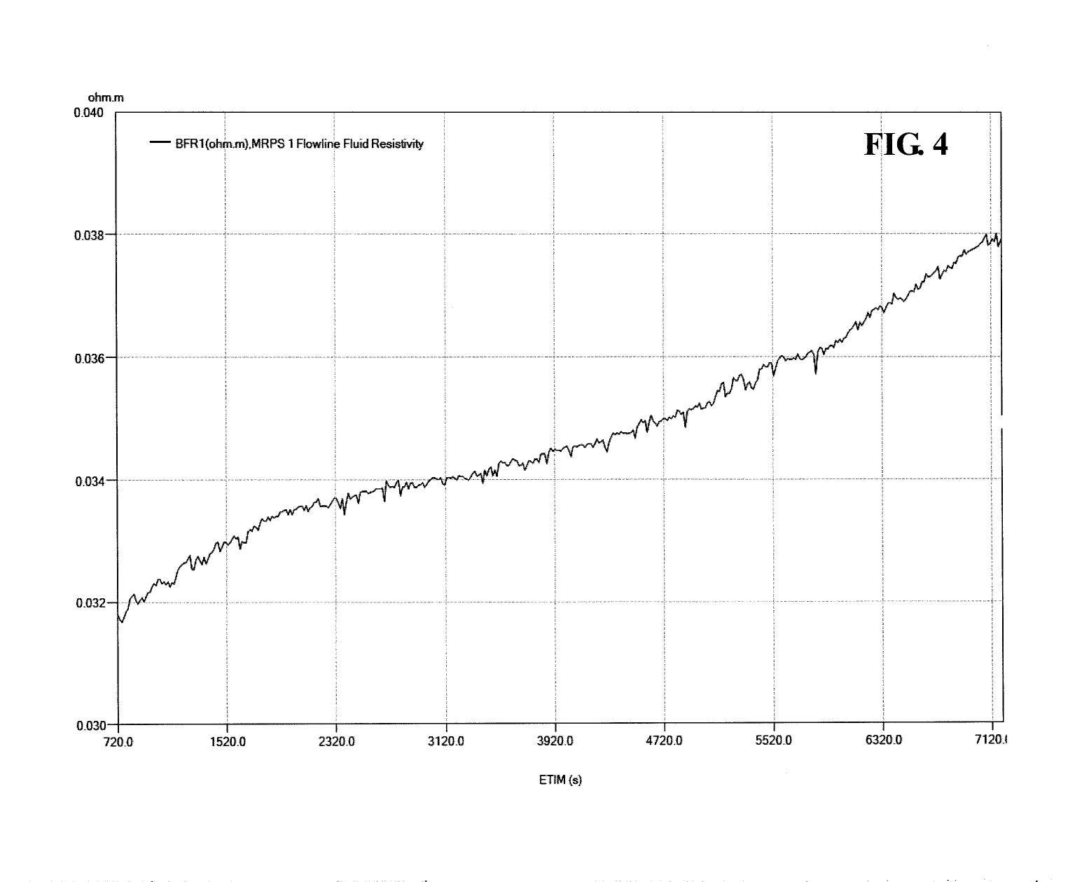

However, for water base mud, DFA and OCM plot may lose its advantage to differentiate water based mud filtrate and formation fluid (especially the formation water), because the optical density (OD) difference between water base mud filtrate and formation water is minor. In addition, during the drilling, since water based mud filtrate invasion depth is very deep, the pumping time can be very long and formation fluid is not often pumped out under the limited pumping time. By only viewing the resistivity change with the time elapse, it is difficult for field engineers to identify whether the formation fluid is pumped out. Shown in FIG. 4 is conventional resistivity v. time plot for water based mud filtrate and formation fluid. Since field engineers do not know the formation fluids resistivity and there is no other indication, field engineers have difficulty to determine whether or not there is a formation fluids flow into the flowline.

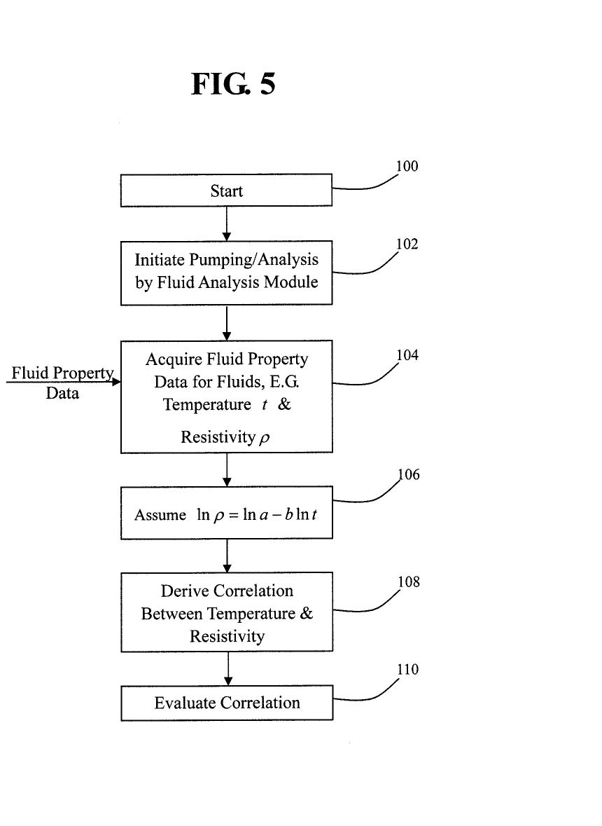

FIG. 5 represents in a flowchart a method for formation fluid detection according to the present invention. When an operation of the fluid analysis module 32 is commenced (Step 100), the probe 28 is extended out to contact with the formation (note FIG. 2). Pumpout module 38 draws fluid into the flowline 33 and drains it to the mud while the fluid flowing in the flowline 33 is analyzed by the module 32 (Step 102). In one embodiment of one method of the present invention, fluid property data for at least two fluids is acquired from the fluid analysis module 32 of the borehole apparatus 20, as exemplarily shown in FIGS. 2 and 3. Typically, the fluid property data includes temperature data of the fluids and resistivity data of the fluids (Step 104).

Instead of looking at conventional resistivity v. time plot, one embodiment of the present invention considers temperature data and resistivity data for the fluids. The present invention assumes the temperature data and the resistivity data having relationship represented by equation (1) ln ρ=ln a−b ln t, wherein ρ represents said resistivity data, t represents said temperature data, and a, b represent first temperature coefficient and second temperature coefficient respectively (Step 106). Assuming formation fluid resistivity will change as the temperature varies under the same salinity, equation (1) ln ρ=ln a−b ln t is derived by conversion from equation (2) ρ=at^{-b}, which is described in “Experimental Study on the Relations between Rock Resistivity and Temperature in Simulating In-situ Conditions,” Li Yanhua, et al., ACTA SCIENTIARUM NATURALIUM UNIVERSITATIS PEKINENSIS, 28(6), 2002. The disclosure of this article is hereby incorporated by reference as though set forth at length.

One embodiment of the present invention then computes the temperature data and resistivity data log—log plot for the fluids (Step 108). For different salinity fluids, such as mud filtrate and formation fluid, the temperature data and resistivity data log—log plot would be different. When the fluid analysis module 32 acquires fluid property data of different kinds of fluids, there would be different lines appearing in the temperature data and resistivity data log—log plot. By identifying whether or not there is a break appearing in temperature data and resistivity data log—log plot, field engineers can evaluate the correlation of temperature data and resistivity data and differentiate different kinds of fluids (Step 110).

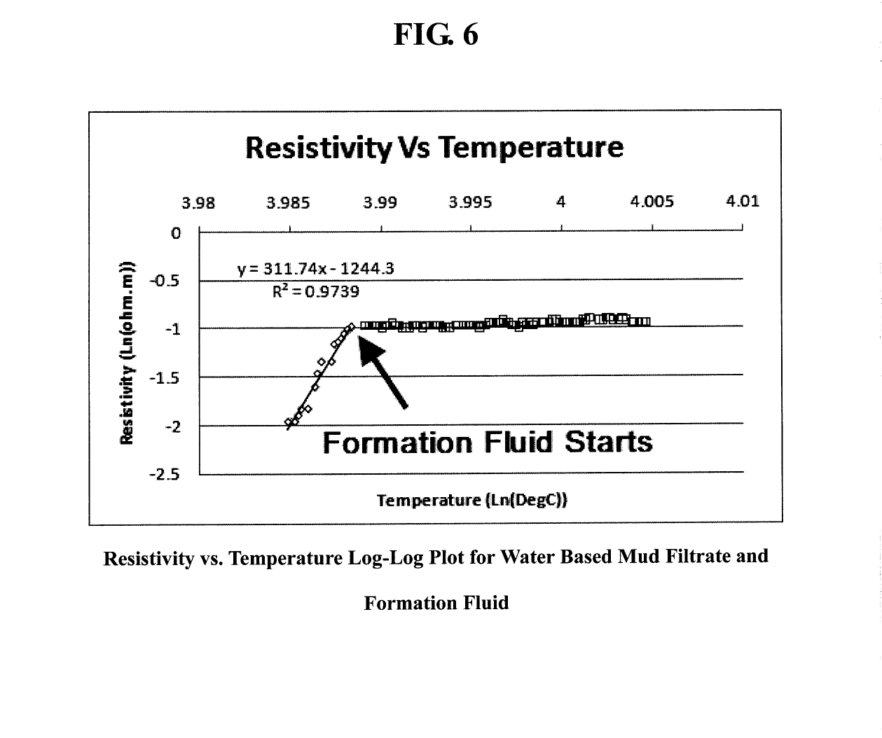

FIG. 6 shows graphical representation of the temperature data and resistivity data log—log plot in accordance with one embodiment of the invention. Specifically in FIG. 6, when an operation of the fluid analysis module 32 is commenced, water based mud filtrate is drawn into the flowline 33 and in real time is analyzed by the module 32. Temperature data and resistivity data of the water based mud filtrate are computed and the temperature data and resistivity data log—log plot for water based mud filtrate is created (note the first line in FIG. 6). After the operation of the fluid analysis module 32 continued for a while, formation fluid is then drawn into the flowline 33 and in real time is analyzed by the module 32. Temperature data and resistivity data of the formation fluid are computed and the temperature data and resistivity data log—log plot for formation fluid is created (note the second line in FIG. 6). Because the temperature data and resistivity data log—log plot of the water based mud filtrate is different from that of the formation fluid, a break appears in temperature data and resistivity data log—log plot. Therefore, by comparing the temperature data and resistivity data log—log plot of the water based mud filtrate and the temperature data and resistivity data log—log plot of the formation fluid field engineers can determine the start of formation fluid pumpout. Additionally, the start of formation fluid pumpout can be identified based on the break point (note FIG. 6 “Formation Fluid Starts”).

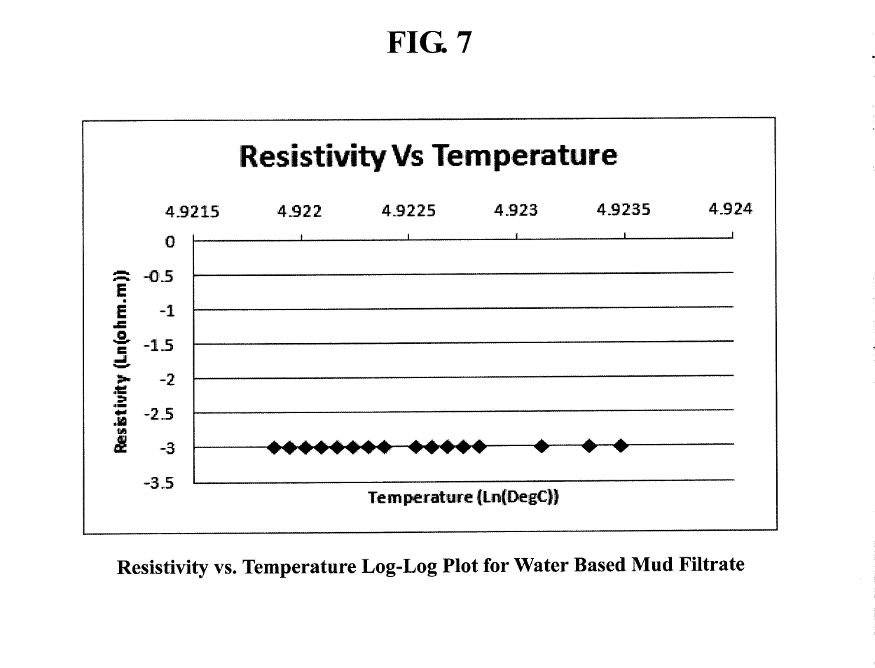

FIG. 7 shows graphical representation of the temperature data and resistivity data log—log plot in accordance with another embodiment of the invention. Specifically in FIG. 7, only water based mud filtrate is drawn into the flowline 33 and in real time is analyzed by the module 32. Temperature data and resistivity data of the water based mud filtrate are computed and the temperature data and resistivity data log—log plot for water based mud filtrate is created (note the line in FIG. 7). Because no break appears in temperature data and resistivity data log—log plot, field engineers can determine to continue pump until the break appears.

The preceding description has been presented only to illustrate and describe the invention and some examples of its implementation. It is not intended to be exhaustive or to limit the invention to any precise form disclosed. Many modifications and variations are possible in light of the above teaching. For example, although water based mud filtrate and formation fluid are chosen to provide graphical representation of the temperature data and resistivity data log—log plot in accordance with one embodiment of the invention, other kinds of fluids can be differentiated using the present invention.

The preferred aspects were chosen and described in order to best explain principles of the invention and its practical applications. The preceding description is intended to enable others skilled in the art to best utilize the invention in various embodiments and aspects and with various modifications as are suited to the particular use contemplated. It is intended that the scope of the invention be defined by the following claims.

What is claimed is:

1. A method for downhole fluid analysis, comprising:
receiving fluid property data for two fluids from a device in a borehole; said fluid property data including temperature data of the fluids and resistivity data of the fluids;
in real time with receiving said fluid property data, deriving correlation between said temperature data and said resistivity data for each fluid; and
evaluating said correlation of the fluids.

2. The method of claim 1, wherein evaluating comprises comparing said correlation of the fluids.

3. The method of claim 1, wherein evaluating comprises identifying difference of said correlation of the two fluids.

4. The method of claim 1, wherein deriving comprises computing said temperature data and said resistivity data log—log plot for the two fluids.

5. The method of claim 4, wherein evaluating comprises identifying difference of said log—log plot of the two fluids.

6. The method of claim 1 further comprising assuming said temperature data and said resistivity data having relationship represented by equation ln ρ=ln a−b ln t, wherein ρ represents said resistivity data, t represents said temperature data, and a, b represent first temperature coefficient and second temperature coefficient respectively.

7. The method of claim 1, wherein said two fluids comprises water based mud filtrate and formation fluid.

8. The method of claim 7, wherein evaluating comprises differentiating the water based mud filtrate and the formation fluid.

9. The method of claim 7, wherein evaluating comprises identifying the formation fluid.

10. The method of claims 5 and 7, wherein evaluating comprises identifying difference of said log—log plot of the water based mud filtrate and the formation fluid.

11. A method of comparing two fluids comprising:
acquiring fluid property data for the two fluids from a device in a borehole, said fluid property data including temperature data of the two fluids and resistivity data of the two fluids; and
analyzing the two fluids based upon correlations of the two fluids, said correlation of each fluid identifying relationship between said temperature data and said resistivity data of each fluid.

12. The method of claim 11 further comprising assuming said temperature data and said resistivity data having relationship represented by equation ln ρ=ln a—b ln t, wherein ρ represents said resistivity data, t represents said temperature data, and a, b represent first temperature coefficient and second temperature coefficient respectively.

13. The method of claim 11, wherein said two fluids comprises water based mud filtrate and formation fluid.

14. The method of claim 12, wherein analyzing comprises differentiating the water based mud filtrate and the formation fluid.

15. The method of claim 12, wherein analyzing comprises identifying the formation fluid.

16. A formation fluid detector configured to operate downhole comprising:
a temperature sensor in contact with fluid acquiring temperature data of the fluid;
a resistivity unit in contact with the fluid providing resistivity data of the fluid; and
a processor coupled to the temperature sensor and the resistivity unit, in real time with receiving said temperature data and said resistivity data of the fluid, deriving correlation between said temperature data and said resistivity data; and evaluating said correlation of the fluid.

17. The formation fluid detector of claim 16, wherein the processor assumes said temperature data and said resistivity data having relationship represented by equation ln ρ=ln a−b ln t, wherein ρ represents said resistivity data, t represents said temperature data, and a, b represent first temperature coefficient and second temperature coefficient respectively.

18. The formation fluid detector of claim 16, wherein the fluid comprises water based mud filtrate.

19. The formation fluid detector of claim 16, wherein the fluid comprises formation fluid.

20. The formation fluid detector of claim 16, wherein the processor detects a change of said correlation.
